(19) United States
(12) Patent Application Publication
(10) Pub. No.: US 2026/0093079 A1
(43) Pub. Date: Apr. 2, 2026

(54) ORGANIC SUBSTRATE FOR CO-PACKAGED OPTICS

(71) Applicant: INTERNATIONAL BUSINESS MACHINES CORPORATION, ARMONK, NY (US)

(72) Inventors: Sayuri Hada, Tokyo (JP); Hiroyuki Mori, Shiga-ken (JP); Akihiro Horibe, Yokohama (JP)

(21) Appl. No.: 18/901,178

(22) Filed: Sep. 30, 2024

(51) Int. Cl. G02B 6/42

(52) U.S. Cl. CPC G02B 6/4278; G02B 6/4259

(57) ABSTRACT

Embodiments of the disclosed invention may include in one aspect, a semiconductor structure. The semiconductor structure may include a silicon chip, a polymer optical waveguide (POW) communicatively attached to a central portion of a bottom side of the silicon chip, and an organic substrate attached to a peripheral portion of the bottom side at least partially surrounding the central portion. The organic substrate may include a first via located at an inner via line and configured to convey a signal from the silicon chip to the organic substrate and a via stress support extending beyond the inner via line toward the central portion.

### BACKGROUND

The present invention relates generally to the field of integrated circuit packaging, and more particularly to improving the structural integrity and reliability of vias in packages using polymer optical waveguides.

Co-packaged optics is an emerging technology that integrates high-bandwidth optical engines directly next to compute chips on the same substrate. This approach significantly shortens the electrical link length, enhancing bandwidth density and energy efficiency compared to traditional pluggable optics. These types of packages are particularly beneficial for data centers and high-performance computing applications, where the consolidated package helps manage the increasing demands for data traffic driven by artificial intelligence, machine learning, and high-resolution video streaming. By leveraging silicon photonics-based optical engines, the packages achieve a high level of integration, using proven semiconductor fabrication technologies to ensure scalability, reliability, and cost-effectiveness.

### SUMMARY

In one aspect, a semiconductor structure includes a silicon chip, a polymer optical waveguide (POW) communicatively attached to a central portion of a bottom side of the silicon chip, and an organic substrate attached to a peripheral portion of the bottom side at least partially surrounding the central portion. The organic substrate may include a first via located at an inner via line and configured to convey a signal from the silicon chip to the organic substrate and a via stress support extending beyond the inner via line toward the central portion.

In another aspect, a semiconductor structure may include a silicon chip and an organic substrate attached to the bottom side of the silicon chip. The organic substrate may include a cutout providing an area for a polymer optical waveguide (POW) to be attached to the silicon chip, a first via located at an inner via line and configured to convey a signal from the silicon chip to the organic substrate; and a via stress support extending beyond the inner via line into the cutout.

In another aspect, a method of forming an semiconductor structure includes fabricating an organic substrate, forming a cutout in the organic substrate, wherein the cutout comprises a via stress support extending beyond an inner via line designating a first via closest to the cutout, attaching a silicon chip to the organic substrate, and attaching a polymer optical waveguide (POW) to the silicon chip within the cutout.

### BRIEF DESCRIPTION OF THE DRAWINGS

The following detailed description, given by way of example and not intend to limit the disclosure solely thereto, will best be appreciated in conjunction with the accompanying drawings.

FIG. 1 depicts a perspective view of a semiconductor structure, generally designated 100, in accordance with an embodiment of the present invention.

FIG. 2 depicts a zoomed-in perspective view of the semiconductor structure of FIG. 1, in accordance with one embodiment of the present invention.

FIG. 3 depicts a zoomed-in perspective view of the semiconductor structure of FIG. 1 showing the via stress support.

FIGS. 4A-4D depict a method of forming a semiconductor structure, in accordance with one embodiment of the present invention.

FIG. 5 depicts a cross-sectional side view of a semiconductor structure and a zoomed-in inset of a via, in accordance with one embodiment of the present invention.

FIG. 6 depicts a cross-sectional side view of a semiconductor structure, in accordance with one embodiment of the present invention.

FIG. 7 depicts a cross-sectional side view of a semiconductor structure, in accordance with one embodiment of the present invention.

FIG. 8 depicts a cross-sectional side view of a semiconductor structure, in accordance with one embodiment of the present invention.

FIG. 9 depicts a cross-sectional side view of a semiconductor structure, in accordance with one embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

The present invention relates generally to the field of integrated circuit packaging, and more particularly to improving the structural integrity and reliability of multi-chip packages using optical interconnects.

Optical interconnects use electromagnetic waves (i.e., light) rather than electrical signals to transmit data between different parts of an electronic system. The light may be used over small distances, such as between silicon chips and circuit boards, or larger distances such as across data centers. Unlike traditional electrical interconnects that use copper wires, optical interconnects propagate the light signals across optical fibers or waveguides. The light signals can allow for much higher data transfer rates, lower latency, and reduced power consumption. Compared to electrical interconnects, optical signals provide inherent advantages such as a larger bandwidth-distance product, a higher interconnect density, and an improved power efficiency.

While the benefits of optical signals may someday enable devices that rely fully on optical signals, most devices rely on light signals being incorporated into other existing technology fabricated into silicon chips. Integrated CMOS silicon (Si) photonics technology, for example, can combine optical and electrical functions on a single chip. These Si-photonics may be co-packaged with optics carrying light signals using polymer optical waveguides (POWs). The POWs may be attached to a silicon chip after each has been fabricated separately. Since the polymer of the POWs can be less resistant to the high temperature, the embodiments herein recognize a benefit to forming a cutout in an organic substrate so that the POW can be attached to the silicon chip after the silicon chip is attached to the organic substrate with a high-temperature reflow process. Furthermore, embodiments described herein may include a via stress support as part of the organic substrate to alleviate stress and strain to metal vias in the organic substrate.

Exemplary embodiments now will be described more fully herein with reference to the accompanying drawings, in which exemplary embodiments are shown. In the following detailed description, numerous specific details are set forth in order to provide a thorough understanding of various embodiments of the invention. However, it is to be understood that embodiments of the invention may be practiced without these specific details. As such, this disclosure may be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

For purposes of the description hereinafter, terms such as “upper,” “lower,” “right,” “left,” “vertical,” “horizontal,” “top,” “bottom,” and derivatives thereof shall relate to the disclosed structures and methods, as oriented in the drawing figures. Terms such as “above,” “overlying,” “atop,” “on top,” “positioned on” or “positioned atop” mean that a first element, such as a first structure, is present on a second element, such as a second structure, wherein intervening elements, such as an interface structure may be present between the first element and the second element. The term “direct contact” means that a first element, such as a first structure, and a second element, such as a second structure, are connected without any intermediary conducting, insulating or semiconductor layers at the interface of the two elements.

In the interest of not obscuring the presentation of embodiments of the present invention, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements of various embodiments of the present invention.

As used herein, terms such as “depositing,” “forming,” and the like may refer to the disposition of layers, or portions of materials, in accordance with a given embodiment. Such processes may or may not be different than those used in the standard practice of the art of device fabrication. Such processes include, but are not limited to, atomic layer deposition (ALD), molecular layer deposition (MLD), chemical vapor deposition (CVD), low-pressure chemical vapor deposition (LPCVD), plasma enhanced chemical vapor deposition (PECVD), limited reaction processing CVD (LRPCVD), ultrahigh vacuum chemical vapor deposition (UHVCVD), metalorganic chemical vapor deposition (MOCVD), physical vapor deposition, sputtering, plating, electroplating, evaporation, ion beam deposition, electron beam deposition, laser assisted deposition, chemical solution deposition, or any combination of those methods.

As used herein, terms, such as “forming,” and the like, may refer to processes that alter the structure and/or composition of one or more layers of material or portions of materials in accordance with a given embodiment. For example, such formation processes may include, but are not limited to, exposure to a specific frequency or range of frequencies of electromagnetic radiation, ion implantation techniques, and/or chemical/mechanical polishing (CMP). As used herein, terms, such as “forming,” and the like, may refer to processes that alter the structure of one or more layers of material, or portions of material(s), by removal of a quantity of material, in accordance with a given embodiment. For example, such formation processes may include, but are not limited to, micromachining, microetching, wet and/or dry etching processes, plasma etching processes, or any of the known etching processes in which material is removed.

Those skilled in the art understand that many different techniques may be used to add, remove, and/or alter various materials, and portions thereof, and that embodiments of the present invention may leverage combinations of such processes to produce the structures disclosed herein without deviating from the scope of the present invention.

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary. Accordingly, those of ordinary skill in the art will recognize that various changes and modifications of the embodiments described herein can be made without departing from the scope and spirit of the invention. Some of the process steps, depicted, can be combined as an integrated process step. In addition, descriptions of well-known functions and constructions may be omitted for clarity and conciseness.

Detailed embodiments of the claimed structures and methods are disclosed herein. The method steps described below do not form a complete process flow for manufacturing integrated circuits on semiconductor chips. The present embodiments can be practiced in conjunction with the integrated circuit fabrication techniques for semiconductor chips and devices currently used in the art, and only so much of the commonly practiced process steps are included as are necessary for an understanding of the described embodiments. The figures represent cross-section portions of various semiconductor structures and sub-assembly structures, and are not drawn to scale, but instead are drawn to illustrate the features of the described embodiments. Specific structural and functional details disclosed herein are not to be interpreted as limiting, but merely as a representative basis for teaching one skilled in the art to variously employ the methods and structures of the present disclosure. In the description, details of well-known features and techniques may be omitted to avoid unnecessarily obscuring the presented embodiments.

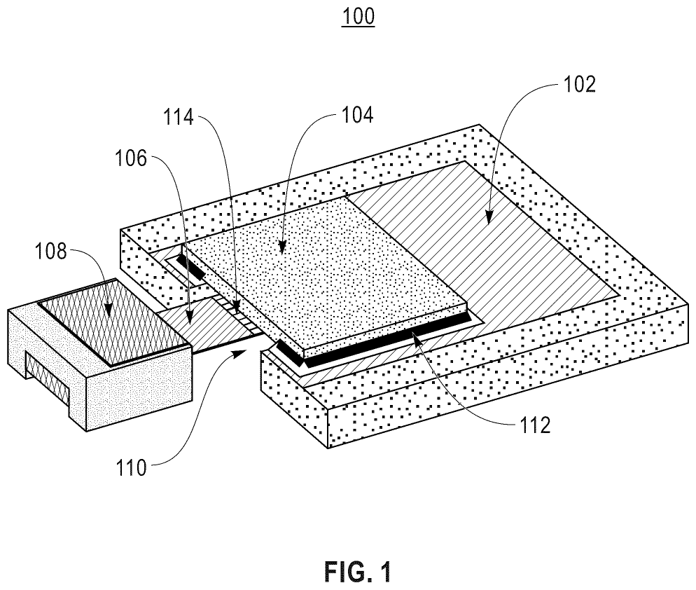

The present invention will now be described in detail with reference to the Figures, wherein like reference numerals refer to like elements throughout. FIGS. 1-9 include various cross-sectional views depicting illustrative steps of a method, and the resulting structures thereof, for manufacturing semiconductor devices, and in particular, a chip-interconnect-chip structure having underfill formed between the chips and interconnect, as well as between the chips themselves, according to select embodiments of the present invention. One having ordinary skill in the art will appreciate that there are many options available for the formation of the structures described herein and that the following discussion does not limit embodiments to only the techniques described herein.

Referring now to the figures, FIG. 1 depicts a perspective view of a semiconductor structure, generally designated 100, in accordance with an embodiment of the present invention. The semiconductor structure 100 includes an organic substrate 102, a silicon chip 104, a polymer optical waveguide (POW) 106, and a ferrule 108. The organic substrate 102 is fabricated in a custom arrangement of devices such that a cutout 110 may be cut, drilled, or otherwise removed from the organic substrate 102 after completion, without affecting the operation of the organic substrate 102 or the silicon chip 104. The silicon chip 104 is communicatively attached to the organic substrate 102, for example using a chip attachment structure 112. Communicatively attached, in this application, means that readable signals from the silicon chip 104 travel to the organic substrate 102 to convey information, and vice versa. The silicon chip 104 is also communicatively attached to the POW 106, using a POW attachment structure 114. The chip attachment structure 112 may include, in some cases, solder that is attached using a heat treatment that melts the solder, which then flows into place and solidifies by cooling back to ambient temperatures. The POW attachment structure 114 generally includes non-heated structures such as an ultra-violet cure resin that may often be used at ambient temperature.

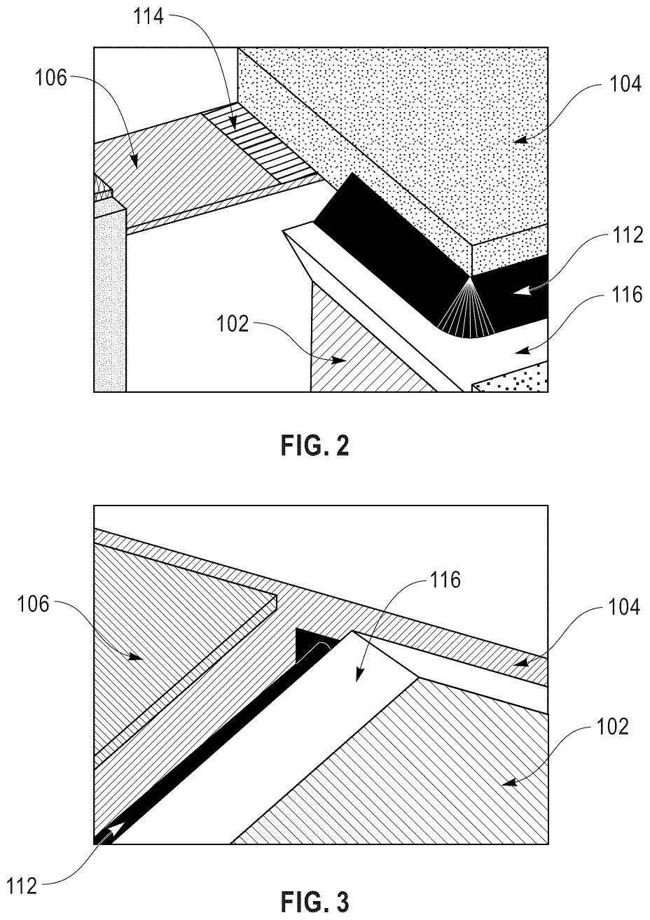

FIG. 2 depicts a zoomed-in perspective view of the semiconductor structure 100, in accordance with one embodiment of the present invention. The semiconductor structure 100 may include a via stress support 116 extending into the cutout 110 to increase the strength and stability of the organic substrate 102 with regard to the chip attachment structure 112. FIG. 3 also depicts a zoomed-in perspective view of the semiconductor structure 100 showing the via stress support 116. The via stress support 116 contains no communication structures but instead extends beyond an inner via line (shown in Figures described below) into the cutout 110. The via stress support 116 may extend around the entire periphery (i.e., the inside boundary around the location where the organic substrate 102 meets the silicon chip 104), or in some embodiments may only be present at specific/targeted areas around the periphery of the cutout 110. These specific area may be at locations where additional support is deemed beneficial for the structural strength of the silicon chip 104 or the organic substrate 102.

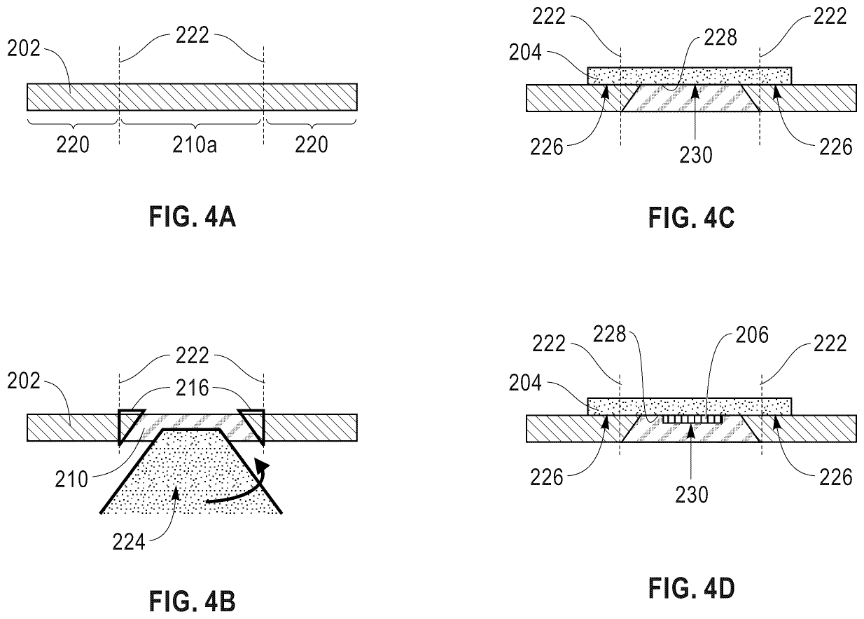

FIGS. 4A-4D depict a method of forming a semiconductor structure 200, in accordance with one embodiment of the present invention. In FIG. 4A, an organic substrate 202 is fabricated with a pattern of connections and vias that reflect the location of a cutout 210. That is, functional regions 220 of the organic substrate 202 include pathways and vias, inter alia, for conveying electrical signals and otherwise performing digital operations. In a cutout region 210a, however, the organic substrate 202 is fabricated with no pathways, vias, or other features for performing digital operations. The boundary between the cutout region 210a and the functional regions 220 is labeled here as an inner via line 222, which designates the location for a first via closest to the cutout region 210a, and represents the extent beyond which no devices (e.g., vias) are fabricated.

FIG. 4B depicts a stage in the method of forming the semiconductor structure 200, in accordance with one embodiment of the present invention. The organic substrate 202 is cut, and a cutout 210 is formed in the organic substrate 202. The cutout 210 includes a via stress support 216 extending beyond the inner via line 222. The via stress support 216 may be formed by leaving material from the organic substrate 202 in the cutout region 210a, or may be formed by depositing material into the cutout 210 after the organic substrate 202 has been removed from the entirety of the cutout region 210a. The cutout 210 may be cut using a beveled drill bit 224 as is illustrated in FIG. 4B, but other methods such as routers, lasers, computer numerical control (CNC) machines, water jets, and punches may also be used to form the cutout 210 and the via stress support 216.

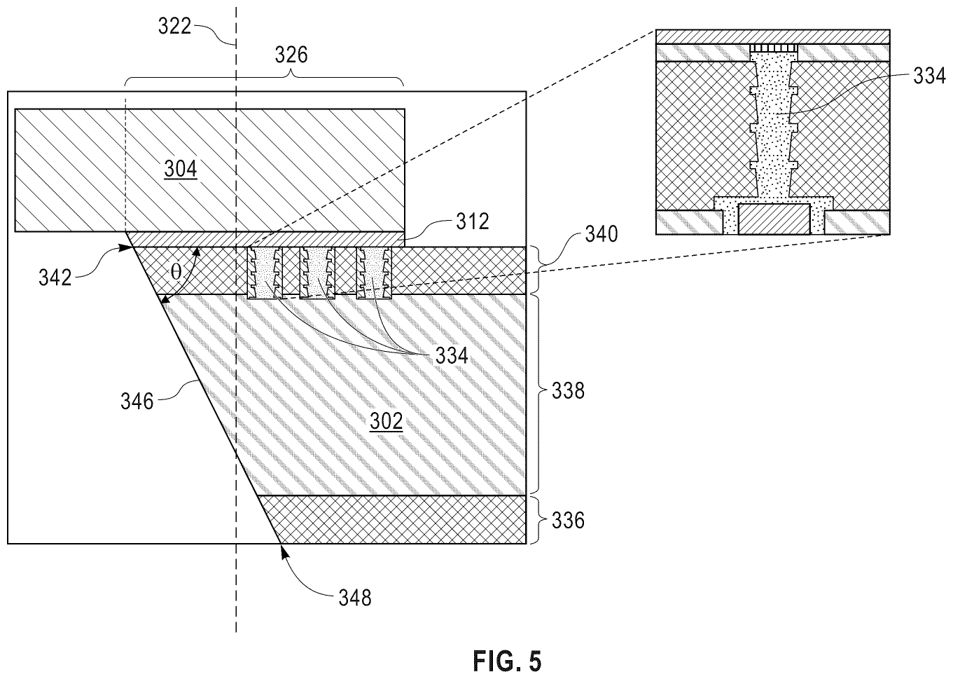

FIG. 4C depicts a stage in the method of forming the semiconductor structure 200, in accordance with one embodiment of the present invention. A silicon chip 204 is attached to the organic substrate 202. The organic substrate 202 is attached to a peripheral portion 226 of a bottom side 228 at least partially surrounding a central portion 230 of the silicon chip 204. As mentioned above, the silicon chip 204 may be attached to the organic substrate 202 using solder, such as solder balls, that melt and flow into place, and then solidify to secure the silicon chip 204 to the organic substrate 202. The silicon chip 204 is aligned carefully to enable communicative attachment between vias in the organic substrate 202 to match with connections in the silicon chip 204. The vias are depicted in more detail in FIG. 5. The via stress supports 216 do not include vias, but reduce the stress that the vias may be subjected to during attachment of the silicon chip 204 to the organic substrate 204, or during other fabrication operations subsequent to the attachment. In certain embodiments, the silicon chip 204 may be attached with a different chip attachment structure on the via stress supports 216 than the solder that is used in the functional region 220 (i.e., to attach the silicon chip 204 communicatively to the vias of the organic substrate 202).

FIG. 4D depicts a stage in the method of forming the semiconductor structure 200, in accordance with one embodiment of the present invention. A POW 206 is communicatively attached to the central portion 230 of the bottom side 228 of the silicon chip 202. The POW 206 may be attached using a POW attachment structure that does not require heat. Indeed, in certain embodiments, the POW 206 may include components that may potentially be damaged by the temperatures at which the solder is melted to attach the silicon chip 204 to the organic substrate 202 in the step illustrated in FIG. 4C. The cutout 110 provides the space in the central portion 230 of the silicon chip 204 to attach the POW 206, which provides the benefit of secure connection with the POW 206. The via stress supports 216 provide structural integrity to the connection between the silicon chip 204 and the organic substrate 202 such that the operation to attach the POW 206 to the silicon chip 204 is less likely to damage any of: the silicon chip 204, the organic substrate 202, or the POW 206.

FIG. 5 depicts a cross-sectional side view of a semiconductor structure 300 and a zoomed-in inset of a via 334, in accordance with one embodiment of the present invention. As is the case with other figures, the components are not necessarily drawn to scale. The semiconductor structure 300 includes a silicon chip 304 communicatively attached to an organic substrate 302 using a chip attachment structure 312. A cutout 310 enables a POW (not pictured) to attach to a central portion of the silicon chip 304 while the organic substrate 302 is attached at a peripheral portion 326 of the silicon chip 304. The attached portion of the organic substrate 302 includes the vias 334, which are attached to unpictured complementary components in the silicon chip 304.

FIG. 5 also illustrates that the organic substrate 302 may include layers: a bottom build-up 336, a core 338, and a top build-up 340. The different layers 336, 338, 340 may be fabricated with specific components, for example, the vias 334 are typically fabricated in the top build-up 340, and other components are fabricated in the core 338 and receive signals through the vias 334 from the silicon chip 304. An inner via line 322 designates the furthest extent of the organic substrate 302, toward the cutout 310 that may include vias 334. A via stress support 316, on the other hand, extends beyond the inner via line 322 and attaches to the silicon chip 304 to alleviate stresses on the vias 334. In particular, a top corner 342 extends beyond the inner via line 322 and forms a support angle 344 of a distal end surface 346 of the via stress support 316 from the top corner 342 to a bottom corner 348 of the organic substrate 302. The bottom corner 348, as illustrated, may be retracted inside the inner via line 322 at a position further from the central portion 330 than the inner via line.

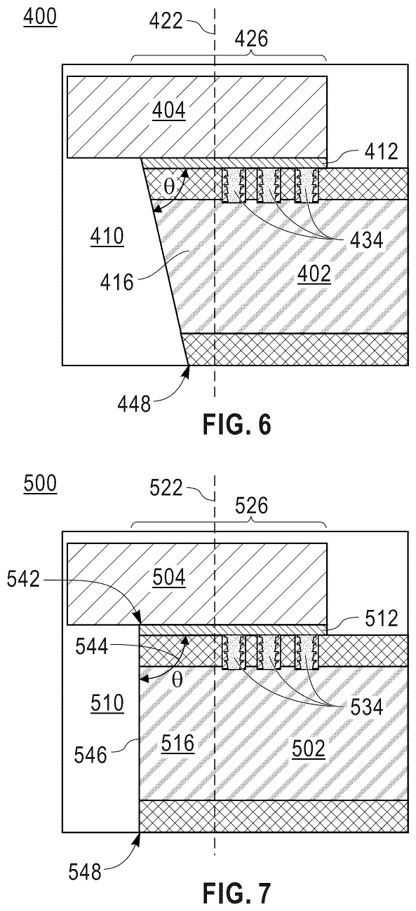

FIG. 6 depicts a cross-sectional side view of a semiconductor structure 400, in accordance with one embodiment of the present invention. The semiconductor structure 400 includes a silicon chip 404 communicatively attached to an organic substrate 402 using a chip attachment structure 412. A cutout 410 enables a POW (not pictured) to attach to a central portion of the silicon chip 404 while the organic substrate 402 is attached at a peripheral portion 426 of the silicon chip 404. The attached portion of the organic substrate 402 includes the vias 434, which are attached to unpictured complementary components in the silicon chip 402. The semiconductor structure 400 illustrates that a bottom corner 448 of a via stress support 416 may extend into cutout 410 beyond an inner via line 422 in a position closer to a central portion (of a silicon chip 404) than the inner via line 422. The semiconductor structure 400 may provide the benefit of safer formation of the cutout 410, since the formation technique can avoid vias 434 in the organic substrate 402 without requiring accuracy on the order of the size of the vias 434. Additionally, the via stress support 416 supports and strengthens the attachment of the silicon chip 404 and the organic substrate 404 so that the vias 434 receive less stress and strain during fabrication and transport of the semiconductor structure 400.

FIG. 7 depicts a cross-sectional side view of a semiconductor structure 500, in accordance with one embodiment of the present invention. The semiconductor structure 500 includes a silicon chip 504 communicatively attached to an organic substrate 502 using a chip attachment structure 512. A cutout 510 enables a POW (not pictured) to attach to a central portion of the silicon chip 504 while the organic substrate 502 is attached at a peripheral portion 526 of the silicon chip 504. The attached portion of the organic substrate 502 includes the vias 534, which are attached to unpictured complementary components in the silicon chip 502. The semiconductor structure 500 illustrates that a bottom corner 548 of a via stress support 516 may extend into cutout 510 beyond an inner via line 522 in a position closer to a central portion (of a silicon chip 504) than the inner via line 522 that is even with a top corner 542. This relationship between the corners 542, 548 means that a support angle 544 is 90 degrees, and a distal end surface 546 is perpendicular to the silicon chip 504. The semiconductor structure 500 and the via stress support 516 provide the benefit of supporting and strengthening the attachment of the silicon chip 504 and the organic substrate 504 so that the vias 534 receive less stress and strain during fabrication and transport of the semiconductor structure 500.

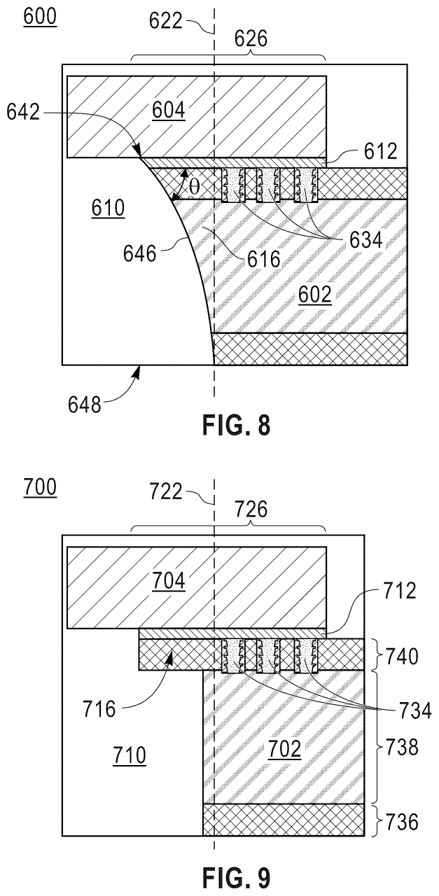

FIG. 8 depicts a cross-sectional side view of a semiconductor structure 600, in accordance with one embodiment of the present invention. The semiconductor structure 600 includes a silicon chip 604 communicatively attached to an organic substrate 602 using a chip attachment structure 612. A cutout 610 enables a POW (not pictured) to attach to a central portion of the silicon chip 604 while the organic substrate 602 is attached at a peripheral portion 626 of the silicon chip 604. The attached portion of the organic substrate 602 includes the vias 634, which are attached to unpictured complementary components in the silicon chip 602. The semiconductor structure 600 illustrates that a bottom corner 648 of a via stress support 616 may be on an inner via line 622 while a top corner 640 extends into the cutout 610 beyond the inner via line 622 in a position closer to a central portion (of a silicon chip 604) than the inner via line 622. A distal end surface 646 may be curved to provide the benefit less material weighing down the organic substrate 602 while still providing the benefit of the via stress support 616 supporting and strengthening the attachment of the silicon chip 604 and the organic substrate 604 so that the vias 634 receive less stress and strain during fabrication and transport of the semiconductor structure 600.

FIG. 9 depicts a cross-sectional side view of a semiconductor structure 700, in accordance with one embodiment of the present invention. The semiconductor structure 700 includes a silicon chip 704 communicatively attached to an organic substrate 702 using a chip attachment structure 712. A cutout 710 enables a POW (not pictured) to attach to a central portion of the silicon chip 704 while the organic substrate 702 is attached at a peripheral portion 726 of the silicon chip 704. The attached portion of the organic substrate 702 includes the vias 734, which are attached to unpictured complementary components in the silicon chip 702. The semiconductor structure 700 illustrates a step-type via stress support 716 where a top build-up 740 of the organic substrate 702 extends into the cutout 710 further than a core 738 or a bottom build-up 736. The core 738 and the bottom build-up 736 may extend into the cutout 710 beyond an inner via line 722 in a position closer to a central portion (of the silicon chip 704). The semiconductor structure 700 may provide the benefit of safer formation of the cutout 710, since the formation technique can avoid vias 734 in the organic substrate 702 without requiring accuracy on the order of the size of the vias 734. Additionally, the via stress support 716 supports and strengthens the attachment of the silicon chip 704 and the organic substrate 704 so that the vias 734 receive less stress and strain during fabrication and transport of the semiconductor structure 700.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiment, the practical application or technical improvement over technologies found in the marketplace, or to enable other of ordinary skill in the art to understand the embodiments disclosed herein.

In addition, any specified material or any specified dimension of any structure described herein is by way of example only. Furthermore, as will be understood by those skilled in the art, the structures described herein may be made or used in the same way regardless of their position and orientation. Accordingly, it is to be understood that terms and phrases such as, for instance, “side”, “over”, “perpendicular”, “tilted”, etc., as used herein refer to relative location and orientation of various portions of the structures with respect to one another, and are not intended to suggest that any particular absolute orientation with respect to external objects is necessary or required.

The foregoing specification also describes processing steps. While some of the steps may be in an ordered sequence, others may in different embodiments from the order that they were detailed in the foregoing specification. The ordering of steps when it occurs is explicitly expressed, for instance, by such adjectives as, “ordered”, “before”, “after”, “following”, and others with similar meaning.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature, or element, of any or all the claims.

Many modifications and variations of the present invention are possible in light of the above teachings, and could be apparent for those skilled in the art.

What is claimed is:

1. A semiconductor structure, comprising:
a silicon chip;
a polymer optical waveguide (POW) communicatively attached to a central portion of a bottom side of the silicon chip; and
an organic substrate attached to a peripheral portion of the bottom side at least partially surrounding the central portion, comprising:
a first via located at an inner via line and configured to convey a signal from the silicon chip to the organic substrate; and
a via stress support extending beyond the inner via line toward the central portion.

2. The semiconductor structure of claim 1, wherein the via stress support comprises a support angle of a distal end surface of the via stress support from a top corner to a bottom corner of the organic substrate.

3. The semiconductor structure of claim 2, wherein the support angle is less than 90 degrees.

4. The semiconductor structure of claim 2, wherein the bottom corner is located at a position selected from the group consisting of: a first position closer to the central portion than the inner via line, a second position further from the central portion than the inner via line, and a third position on the inner via line.

5. The semiconductor structure of claim 2, wherein the distal end surface is curved.

6. The semiconductor structure of claim 1, wherein the organic substrate comprises:
a core;
a top build-up above the core, wherein the first via is located in the top build-up and is configured to convey a signal from the silicon chip to the core; and
a bottom build-up below the core.

7. The semiconductor structure of claim 6, wherein the via stress support only extends the top build-up beyond the inner via line.

8. The semiconductor structure of claim 1, wherein the via stress support comprises a support height that is less than a height of the organic substrate.

9. The semiconductor structure of claim 1, wherein the POW is attached to the silicon chip using a thermally sensitive adhesive.

10. The semiconductor structure of claim 1, wherein the silicon chip comprises a rectangular shape, and the organic substrate is attached on at least three of four sides of the silicon chip.

11. A semiconductor structure, comprising:
a silicon chip; and
an organic substrate attached to the bottom side of the silicon chip, comprising:
a cutout providing an area for a polymer optical waveguide (POW) to be attached to the silicon chip;
a first via located at an inner via line and configured to convey a signal from the silicon chip to the organic substrate; and
a via stress support extending beyond the inner via line into the cutout.

12. The semiconductor structure of claim 11, wherein the via stress support comprises a support angle of a distal end surface of the support structure from a top corner to a bottom corner of the organic substrate.

13. The semiconductor structure of claim 12, wherein the support angle is less than 90 degrees.

14. The semiconductor structure of claim 12, wherein the bottom corner is located at a position selected from the group consisting of: a first position closer to the central portion than the inner via line, a second position on the inner via line, and a third position further from the central portion than the inner via line.

15. The semiconductor structure of claim 12, wherein the distal end surface is curved.

16. The semiconductor structure of claim 11, wherein the organic substrate comprises:
a core;
a top build-up above the core, wherein the first via is located in the top build-up and is configured to convey a signal from the silicon chip to the core; and
a bottom build-up below the core.

17. A method of forming a semiconductor structure, comprising:
fabricating an organic substrate;
forming a cutout in the organic substrate, wherein the cutout comprises a via stress support extending beyond an inner via line designating a first via closest to the cutout;
attaching a silicon chip to the organic substrate; and
attaching a polymer optical waveguide (POW) to the silicon chip within the cutout.

18. The method of claim 17, wherein the cutout is formed using a beveled cutting tool to form a support angle of a distal end surface of the via stress support from a top corner to a bottom corner of the organic substrate.

19. The method of claim 18, wherein the support angle is less than 90 degrees.

20. The method of claim 18, wherein the bottom corner is located at a position selected from the group consisting of: a first position closer to the central portion than the inner via line, a second position on the inner via line, and a third position further from the central portion than the inner via line.
